(19) United States
(12) Patent Application Publication
(10) Pub. No.: US 2015/0221193 A1
(43) Pub. Date: Aug. 6, 2015

(54) Intrusion Detection and Video Surveillance Activation and Processing

(71) Applicant: Aruba Networks, Inc., Sunnyvale, CA (US)

(72) Inventor: Venu Pragada, San Jose, CA (US)

(73) Assignee: Aruba Networks, Inc., Sunnyvale, CA (US)

(21) Appl. No.: 14/172,880

(22) Filed: Feb. 4, 2014

(51) Int. Cl. G08B 13/196; G06F 21/60; G06F 21/50; H04N 7/18; G06K 9/00

(52) U.S. Cl. CPC G08B 13/19613; H04N 7/185; H04N 7/188; G06K 9/00771; G06F 21/50; G06F 21/60; G08B 13/19617; G08B 13/19663; G08B 13/19665

(57) ABSTRACT

The present disclosure discloses a system and method for detection network intrusion and activating a video surveillance system based on the network intrusion detection and processing video data accordingly. A network intrusion event caused by a particular device is detected. Responsive to responsive to detecting the network intrusion event, a current physical location of the particular device is estimated. Based on the current physical location, one or more predicted locations of the particular device are estimated. A video stream comprising images of the estimated one or more predicted locations of the particular device.

### FIELD

The present disclosure relates to detection of network intrusion by an unknown device. In particular, the present disclosure relates to detection of network intrusion by an unknown device and video surveillance activation and processing.

### BACKGROUND

Networks, particularly wireless networks, are often targeted by intruders intending to obtain access to the network and its resources. For example, attackers who are in proximity to a wireless network may attempt to hack into the wireless network in order to gain access to an internal network, steal company data or to gain free Internet access. Protecting network infrastructure and corporate data from external attackers is important for security of the company data and protection against unauthorized interlopers.

### BRIEF DESCRIPTION OF THE DRAWINGS

The present disclosure may be best understood by referring to the following description and accompanying drawings that are used to illustrate embodiments of the present disclosure.

FIG. 1 is a block diagram illustrating an example network environment according to embodiments of the present disclosure.

FIG. 2 is a block diagram illustrating an example network device for intrusion detection according to embodiments of the present disclosure.

FIG. 3 is a block diagram illustrating an example surveillance system according to embodiments of the present disclosure.

FIG. 4 is a block diagram illustrating an example intrusion detection application according to some embodiments of the present disclosure. The application is stored on a memory of the example network device or system.

FIG. 5 illustrates an example process for intrusion detection and video surveillance according to embodiments of the present disclosure.

FIG. 6 illustrates another example process for intrusion detection and video surveillance according to embodiments of the present disclosure.

FIG. 7 illustrates an example process for device tracking and video surveillance according to embodiments of the present disclosure.

### DETAILED DESCRIPTION

In the following description, several specific details are presented to provide a thorough understanding. While the context of the disclosure is directed to task processing and resource sharing in a distributed wireless system, one skilled in the relevant art will recognize, however, that the concepts and techniques disclosed herein can be practiced without one or more of the specific details, or in combination with other components, etc. In other instances, well-known implementations or operations are not shown or described in details to avoid obscuring aspects of various examples disclosed herein. It should be understood that this disclosure covers all modifications, equivalents, and alternatives falling within the spirit and scope of the present disclosure.

### Overview

Embodiments of the present disclosure relates to detection of network intrusion by an unknown device. In particular, the present disclosure relates to detection of network intrusion by an unknown device and video surveillance activation and processing. Specifically, a network intrusion event caused by a particular device is detected. Responsive to responsive to detecting the network intrusion event, a current physical location of the particular device is estimated. Based on the current physical location, one or more predicted locations of the particular device are estimated. A video stream comprising images of the estimated one or more predicted locations of the particular device.

In some embodiments, a network intrusion event caused at least by a particular device is detected. Responsive to detecting the network intrusion event, one or more physical locations associated with the particular device is determined. Video data collected by a surveillance system is processed using one or more of a plurality of video processing steps that are selected for each particular portion of the video data based on whether or not that particular portion corresponds to the one or more physical locations.

In other embodiments, a determination is made that first device is travelling toward a particular location. Responsive to determining that the first device is travelling toward the particular location, a video stream associated with the particular location is obtained. The video stream is presented on the first device.

### Computing Environment

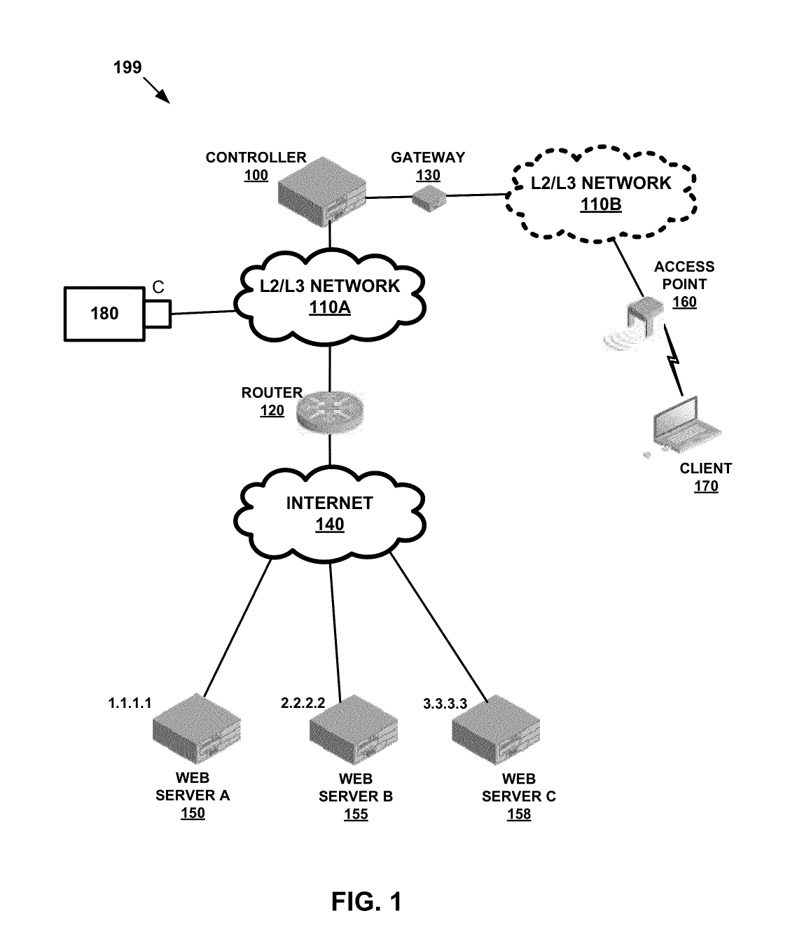

FIG. 1 shows an example digital network environment 199 according to embodiments of the present disclosure. FIG. 1 includes at least one or more network controller (such as controller 100), one or more access points (such as access point 160), one or more client devices (such as client 170), a layer 2 or layer 3 network 110, a routing device (such as router 120), a gateway 130, Internet 140, and one or more web servers (such as web server A 150, web server B 155, and web server C 158), and a surveillance system 180. The components of the digital network environment 199 are communicatively coupled to each other. In some embodiments, the digital network environment 199 may include other components not shown in FIG. 1 such as an email server, a cloud-based storage device, etc. It is intended that any of the servers shown may represent an email server instead as illustrated with email functionalities and any of the network devices may serve as a cloud-based storage device. The network 140 may be implemented within a cloud environment.

The controller 100 is a hardware device and/or software module that provide network managements, which include but are not limited to, controlling, planning, allocating, deploying, coordinating, and monitoring the resources of a network, network planning, frequency allocation, predetermined traffic routing to support load balancing, cryptographic key distribution authorization, configuration management, fault management, security management, performance management, bandwidth management, route analytics and accounting management, etc. In some embodiments, the controller 100 is an optional component in the digital network environment 199.

Moreover, assuming that a number of access points, such as access point 160, are interconnected with the network controller 100. Each access point 160 may be interconnected with zero or more client devices via either a wired interface or a wireless interface. In this example, for illustration purposes only, assuming that the client 170 is associated with the access point 160 via a wireless link. An access point 160 generally refers to a network device that allows wireless clients to connect to a wired network. Access points 160 usually connect to a controller 100 via a wired network or can be a part of a controller 100 in itself. For example, the access point 160 is connected to the controller 100 via an optional L2/L3 network 110B.

Wired interfaces typically include IEEE 802.3 Ethernet interfaces, used for wired connections to other network devices such as switches, or to a controller. Wireless interfaces may be WiMAX, 3G, 4G, and/or IEEE 802.11 wireless interfaces. In some embodiments, controllers and APs may operate under control of operating systems, with purpose-built programs providing host controller and access point functionality.

Furthermore, the controller 100 can be connected to the router 120 through zero or more hops in a layer 3 or layer 2 network (such as L2/L3 Network 110A). The router 120 can forward traffic to and receive traffic from the Internet 140. The router 120 generally is a network device that forwards data packets between different networks, and thus creating an overlay internetwork. A router 120 is typically connected to two or more data lines from different networks. When a data packet comes in one of the data lines, the router 120 reads the address information in the packet to determine its destination. Then, using information in its routing table or routing policy, the router 120 directs the packet to the next/different network. A data packet is typically forwarded from one router 120 to another router 120 through the Internet 140 until the packet gets to its destination.

The gateway 130 is a network device that passes network traffic from local subnet to devices on other subnets. In some embodiments, the gateway 130 may be connected to a controller 100 or be a part of the controller 100 depending on the configuration of the controller 100. In some embodiments, the gateway 130 is an optional component in the digital network environment 199.

Web servers 150, 155, and 158 are hardware devices and/or software modules that facilitate delivery of web content that can be accessed through the Internet 140. For example, the web server A 150 may be assigned an IP address of 1.1.1.1 and used to host a first Internet website (e.g., www.yahoo.com); the web server B 155 may be assigned an IP address of 2.2.2.2 and used to host a second Internet website (e.g., www.google.com); and, the web server C 158 may be assigned an IP address of 3.3.3.3 and used to host a third Internet website (e.g., www.facebook.com).

The client 170 may be a computing device that includes a memory and a processor, for example a laptop computer, a desktop computer, a tablet computer, a mobile telephone, a personal digital assistant (PDA), a mobile email device, a portable game player, a portable music player, a reader device, a television with one or more processors embedded therein or coupled thereto or other electronic device capable of accessing a network. Although only one client 170 is illustrated in FIG. 1, a plurality of clients 170 can be included in FIG. 1.

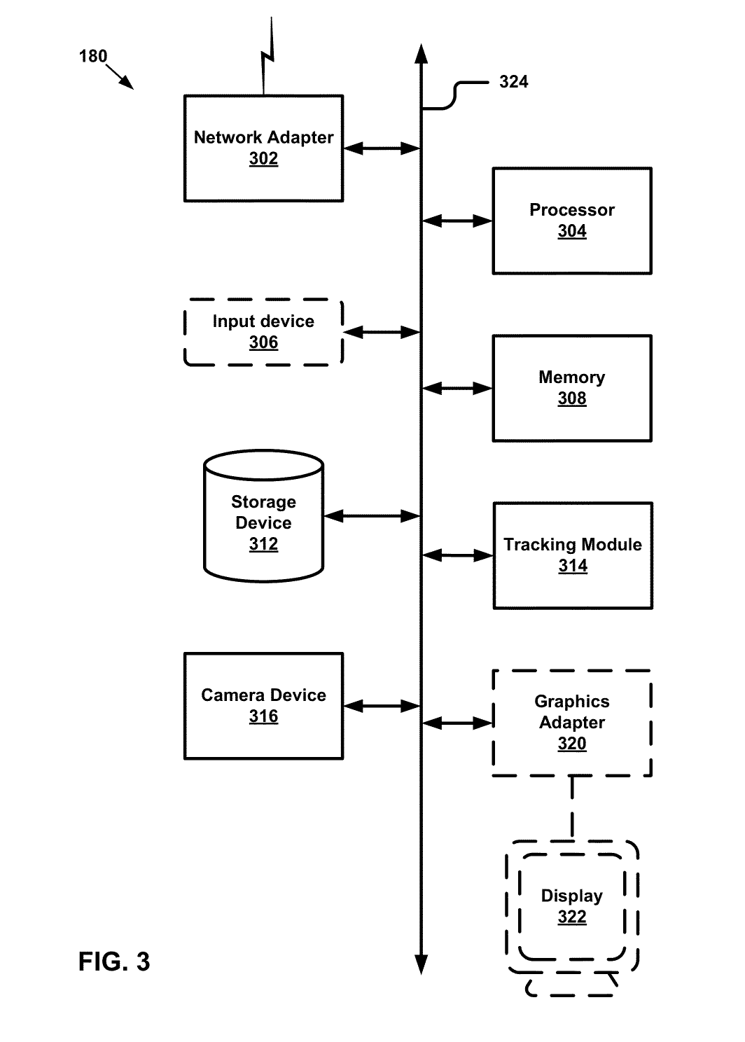

The surveillance system 180 may be any system that observes and/or collects information. In one embodiment, surveillance system 116 is a video surveillance system which includes at least one video camera configured to closely and continually monitor physical zones. More details regarding the surveillance system 180 will be provided in the descriptions of FIG. 3.

### Network Device for Intrusion Detection

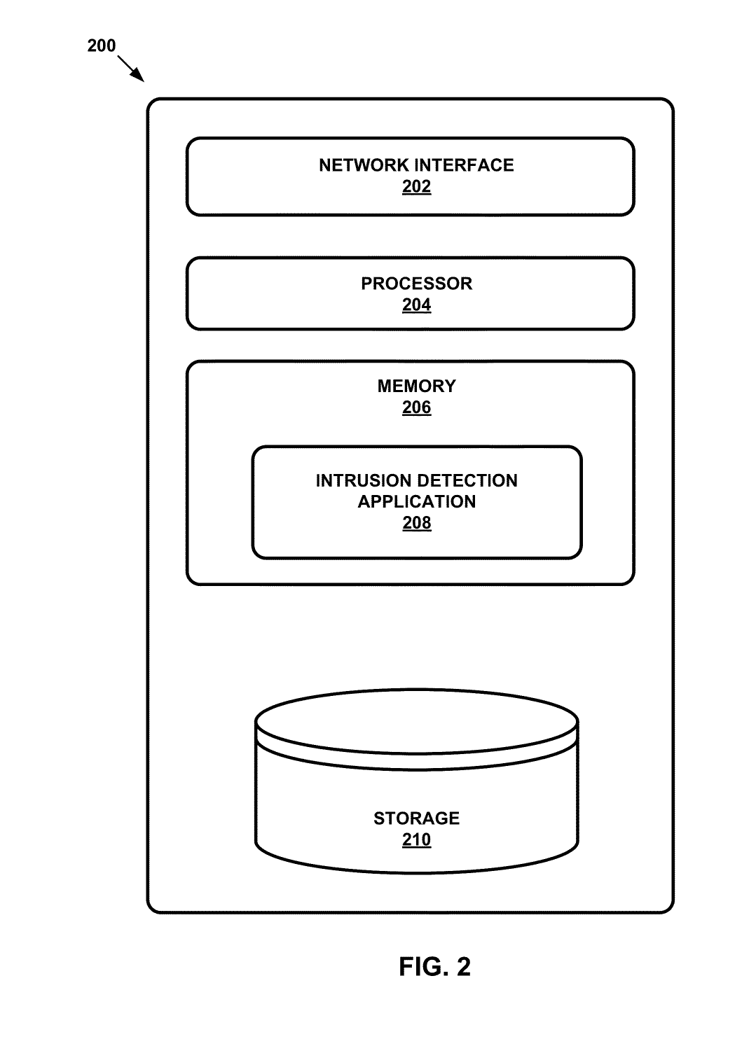

FIG. 2 is a block diagram illustrating an example network device 200 for intrusion detection according to embodiments of the present disclosure. The network device 200 may be used as a network switch, a network router, a network controller, a network server, an access point, etc. Further, the network device 200 may serve as a node in a distributed or a cloud computing environment.

According to embodiments of the present disclosure, network services provided by the network device 200, solely or in combination with other wireless network devices, include, but are not limited to, an Institute of Electrical and Electronics Engineers (IEEE) 802.1x authentication to an internal and/or external Remote Authentication Dial-In User Service (RADIUS) server; an MAC authentication to an internal and/or external RADIUS server; a built-in Dynamic Host Configuration Protocol (DHCP) service to assign wireless client devices IP addresses; an internal secured management interface; Layer-3 forwarding; Network Address Translation (NAT) service between the wireless network and a wired network coupled to the network device; an internal and/or external captive portal; an external management system for managing the network devices in the wireless network; etc. In some embodiments, the network device or system 200 may serve as a node in a distributed or a cloud computing environment.

In some embodiments, the network device 200 includes a network interface 202 capable of communicating to a wired network, a processor 204, a memory 206 and a storage device 210. The components of the network device 200 are communicatively coupled to each other.

The network interface 202 can be any communication interface, which includes but is not limited to, a modem, token ring interface, Ethernet interface, wireless IEEE 802.11 interface (e.g., IEEE 802.11n, IEEE 802.11ac, etc.), cellular wireless interface, satellite transmission interface, or any other interface for coupling network devices. In some embodiments, the network interface 202 may be software-defined and programmable, for example, via an Application Programming Interface (API), and thus allowing for remote control of the network device 200.

The processor 204 includes an arithmetic logic unit, a microprocessor, a general purpose controller or some other processor array to perform computations and provide electronic display signals to a display device. Processor 204 processes data signals and may include various computing architectures including a complex instruction set computer (CISC) architecture, a reduced instruction set computer (RISC) architecture, or an architecture implementing a combination of instruction sets. Although FIG. 2 includes a single processor 204, multiple processors 204 may be included. Other processors, operating systems, sensors, displays and physical configurations are possible. In some embodiments, the processor 204 includes a networking processor core that is capable of processing network data traffic.

The memory 206 stores instructions and/or data that may be executed by the processor 204. The instructions and/or data may include code for performing the techniques described herein. The memory 206 may be a dynamic random access memory (DRAM) device, a static random access memory (SRAM) device, flash memory or some other memory device. In some embodiments, the memory 206 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

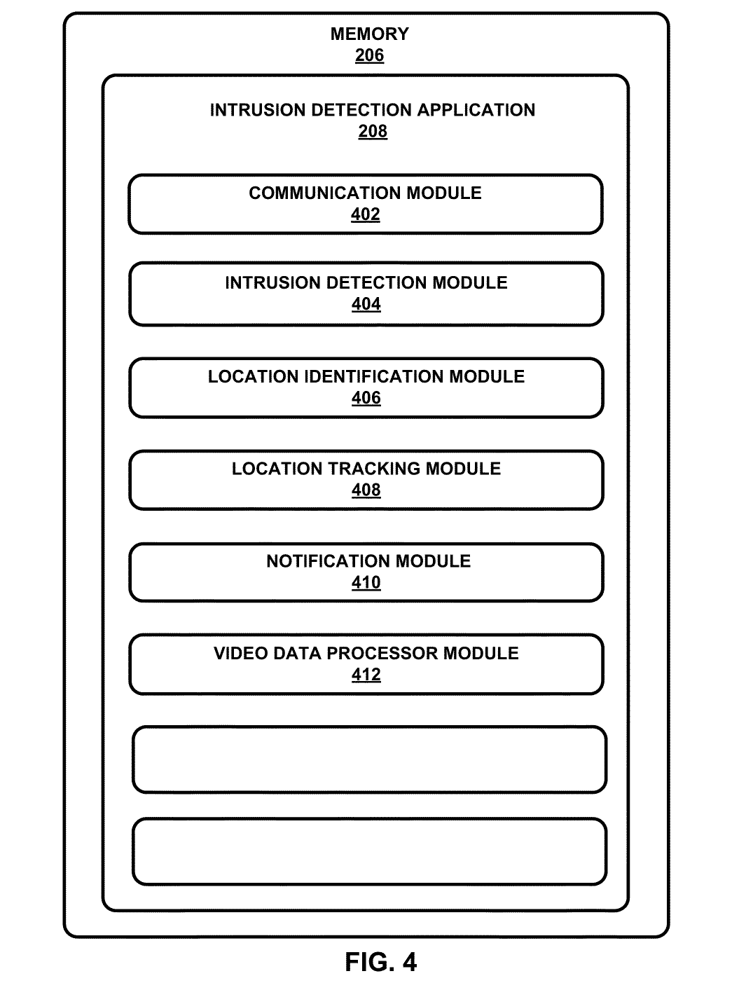

In some embodiments, the memory 206 stores an intrusion detection application 208. The Intrusion detection application 208 can be the code and routines that, when executed by processor 204, cause the network device 200 to implement detection network intrusion and initiating video surveillance accordingly. In some other embodiments, the Intrusion detection application 208 can be located in a controller 100, a router 120, a gateway 130, a switch or any other network device. In some embodiments, the Intrusion detection application 208 can be implemented using hardware including a Field-Programmable Gate Array (FPGA) or an Application-Specific Integrated Circuit (ASIC. In some other embodiments, the Intrusion detection application 208 can be implemented using a combination of hardware and software. In some embodiments, the Intrusion detection application 208 may be stored in a combination of the network devices, or in one of the network devices. The intrusion detection application 208 is described below in more detail with reference to FIGS. 4-7.

The storage device 210 can be a non-transitory memory that stores data for providing the functionality described herein. The storage device 210 may be a dynamic random access memory (DRAM) device, a static random access memory (SRAM) device, flash memory or some other memory devices. In some embodiments, the storage device 210 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

### Surveillance System

FIG. 3 is a block diagram illustrating an example surveillance system 180 according to embodiments of the present disclosure. As illustrated in FIG. 3, the surveillance system 180 includes a network adapter 302 coupled to a bus 324. According to one embodiment, also coupled to the bus 324 are at least one processor 304, memory 308, a tracking module 314, a communication module 326, an input device 306, a storage device 312, and a camera device 316. In one embodiment, the functionality of the bus 324 is provided by an interconnecting chipset. The surveillance system 180 also includes a display 322, which is coupled to the graphics adapter 320.

The processor 304 may be any general-purpose processor. The processor 304 comprises an arithmetic logic unit, a microprocessor, a general purpose controller or some other processor array to perform computations, provide electronic display signals to display 322. The processor 304 is coupled to the bus 324 for communication with the other components of the surveillance system 180. Processor 304 processes data signals and may comprise various computing architectures including a complex instruction set computer (CISC) architecture, a reduced instruction set computer (RISC) architecture, or an architecture implementing a combination of instruction sets. Although only a single processor is shown in FIG. 3, multiple processors may be included. The surveillance system 180 also includes an operating system executable by the processor such as but not limited to WINDOWS®, MacOS X, Android, or UNIX® based operating systems.

The memory 308 holds instructions and data used by the processor 304. The instructions and/or data comprise code for performing any and/or all of the techniques described herein. The memory 308 may be a dynamic random access memory (DRAM) device, a static random access memory (SRAM) device, flash memory or some other memory device known in the art. In one embodiment, the memory 308 also includes a non-volatile memory such as a hard disk drive or flash drive for storing log information on a more permanent basis. The memory 308 is coupled by the bus 324 for communication with the other components of the surveillance system 180. In one embodiment, the tracking module 314 is stored in memory 308 and executable by the processor 304.

The tracking module 314 is software and routines executable by the processor 206 to control components of the surveillance system 180, such as the camera device 316 based on data received from the device 200 for intrusion detection. The tracking module 314 may be configured to track or transform information relating to an approximate physical location of a wireless attacker as obtained from the device 200 for intrusion detection into a physical space, i.e., a physical location that is essentially understood within the domain of surveillance system 180. By way of example, tracking module 314 may be arranged to provide camera and zoom coordinates that enable the approximate physical location of a wireless attacker to essentially be zeroed in upon. The tracking module 314 may provide data to control the selection of and the positioning of camera device 632.

The surveillance system 180 also includes at least camera device 316 to provide video surveillance. Camera device 316 may be a video camera that is configured to capture and record images associated with a zone that is monitored by the camera device 316.

Device management logic 670 also controls the operation of device 632. By way of example, device management logic 670 may be configured to position device 632 to substantially optimize the view of the vicinity an approximate physical location of a wireless attacker

The storage device 312 is any device capable of holding data, like a hard drive, compact disk read-only memory (CD-ROM), DVD, or a solid-state memory device. The storage device 312 is a non-volatile memory device or similar permanent storage device and media. The storage device 214 stores data and instructions for processor 304 and comprises one or more devices including a hard disk drive, a floppy disk drive, a CD-ROM device, a DVD-ROM device, a DVD-RAM device, a DVD-RW device, a flash memory device, or some other mass storage device known in the art. In some embodiments, video data is stored in the storage device 312.

The input device 306 may include a mouse, track ball, or other type of pointing device to input data into the social network server 101. The input device 306 may also include a keyboard, such as a QWERTY keyboard. The input device 306 may also include a microphone, a web camera or similar audio or video capture device. The graphics adapter 320 displays images and other information on the display 322. The display 322 is a conventional type such as a liquid crystal display (LCD) or any other similarly equipped display device, screen, or monitor. The display 322 represents any device equipped to display electronic images and data as described herein. The network adapter 302 couples the surveillance system 180 to a local or wide area network. The network adapter 302 may also facilitate communication between the surveillance system 180 and the device 200 for intrusion detection.

Display 322 allows video captured by camera device 316 to be displayed for viewing by other parties, such as IT administrators and/or security personnel. The configuration of display 322 may vary widely, and may include any number of screens or windows. Display 322 may include a graphical user interface which enables users to select views from the camera device 316 to display, and may also allow a user to zoom the camera device 316 to provide more detailed views. Display 322 may display a window that identifies a particular view as being a view of an approximate physical location at which an attacking intruder is located. That is, display 322 may be arranged to clearly indicate that the presence of a wireless client is to be monitored, and that a particular view is intended to be used to facilitate the tracing or tracking of the wireless client.

As is known in the art, the surveillance system 180 can have different and/or other components than those shown in FIG. 3. In addition, the surveillance system 180 can lack certain illustrated components. In one embodiment, the surveillance system 180 lacks an input device 306, graphics adapter 320, and/or display 322. Moreover, the storage device 312 can be local and/or remote from the surveillance system 180 (such as embodied within a storage area network (SAN)).

As is known in the art, the surveillance system 180 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 312, loaded into the memory 308, and executed by the processor 304.

Embodiments of the entities described herein can include other and/or different modules than the ones described here. In addition, the functionality attributed to the modules can be performed by other or different modules in other embodiments. Moreover, this description occasionally omits the term “module” for purposes of clarity and convenience.

### Intrusion Detection Application

FIG. 4 is a block diagram illustrating an example intrusion detection application according to some embodiments of the present disclosure. The application is stored on a memory of the example network device or system. In some embodiments, the Intrusion detection application 208 includes a communication module 302, an intrusion detection module 404, a location identification module 406, a location tracking module 408, a notification module 410, and a video data processor module 412.

The intrusion detection application 208 can be software including routines for detecting unauthorized network intrusion. In some embodiments, the intrusion detection application 208 can be a set of instructions executable by the processor 204 to provide the functionality described herein. In some other embodiments, the intrusion detection application 208 can be stored in the memory 206 and can be accessible and executable by the processor 204.

The intrusion detection application 208 detects a network intrusion event that is being caused by a particular device. The intrusion detection application 208 also estimates a current physical location of the particular device in response to the detection of the network intrusion event. The intrusion detection application 208 also estimates 506 one or more predicted locations of the particular device based on the physical location and processes 508 a video stream comprising images of the estimates one or more predicted locations of the particular device.

The communication module 302 can be software including routines for handling communications between the network intrusion application 208 and other components in the digital computing environment 199 (FIG. 1), including the surveillance system 180. In some embodiments, the communication module 302 can be a set of instructions executable by the processor 204 to provide the functionality described herein. In some other embodiments, the communication module 302 can be stored in the memory 206 of the network intrusion application 208 and can be accessible and executable by the processor 204.

In some embodiments, the communication module 302 may be adapted for cooperation and communication with the processor 204 and other components of the network intrusion application 208 such as the network interface 202, the storage 210, etc.

In some embodiments, the communication module 302 sends and receives data to and from one or more of a client 170 (FIG. 1), an access point 160 (FIG. 1) and other network devices via the network interface 202 (FIG. 2), in the event of distributed functionalities. In some embodiments, the communication module 302 handles communications between components of the Intrusion detection application 208. In some embodiments, the communication module 302 receives data from other components of the network intrusion application 208 and stores the data in the storage device 210.

The intrusion detection module 404 can be software including routines for detecting network intrusion. In some embodiments, the intrusion detection module 404 can be a set of instructions executable by the processor 204 to provide the functionality described herein. In some other embodiments, the location tracking module 408 can be stored in the memory 206 of the Intrusion detection application 208 and can be accessible and executable by the processor 204.

The intrusion detection module 404 detects a network intrusion event that is being caused by a particular device. In some embodiments, the network intrusion event includes a client device with a particular role connecting to an access point where no client devices with that particular role are expected to connect to that access point. In other embodiments, the network intrusion event may include, but are not limited to the following examples: detection of a rogue access point, DOS attacks, AP spoofing, MAC spoofing, detection of trap set to detect, deflect, or, in some manner, counteract attempts at unauthorized use of the network, a de-authentication broadcast, or any other alert from the network based on network actions.

The location identification module 406 can be software including routines for determining a location of the network intrusion and determining one or more predicted locations. In some embodiments, the location identification module 406 can be a set of instructions executable by the processor 204 to provide the functionality described herein. In some other embodiments, the location identification module 406 can be stored in the memory 206 of the Intrusion detection application 208 and can be accessible and executable by the processor 204.

In some embodiments, the location identification module 406 estimates a current physical location of the particular device in response to the detection of the network intrusion event. Based on the physical location, the location identification module 406 of the intrusion detection application 208 estimates one or more predicted locations of the particular device. In some embodiments, the one or more predicted locations correspond to one or more physical pathways by which a device causing the network intrusion may exit a physical environment from the current physical location. For example, in some embodiments, the one or more predicted locations can be a pathway that leads to an exit of the premises. As another example, in other embodiments, the one or more predicted locations can be all the pathways that lead to an exit from the premises. In some embodiments, the one or more predicted locations are estimated based on the current physical location and a detected direction of travel of the particular device. For example, if a current physical location is detected and the current physical location is located near a stairway, then the one or more predicted locations is the stairway. In such embodiments, the notification module 410 of the intrusion detection application 208 instructs the surveillance system 180 to record the stairway.

In some embodiments, the one or more predicted locations may be a high security zone near the current physical location of the particular device. In other embodiments, the one or more predicted locations may be a high priority zone near the current physical location of the particular device. In yet other embodiments, the one or more predicted locations may be a second current physical location for an individual near the current physical location of the particular device. For example, the one or more predicted locations may be a bank safe. As another example, the one or more predicted locations may be a white room or IT core infrastructure. In such embodiments mention above, where the one or more predicted locations may be a high security zone near the current physical location of the particular device, the proximity may be defined as a distance proximity. However, in some embodiments, the proximity may not necessarily be defined as a distance proximity, but may also be defined as locations that are associated with each other (for example, part of the same department, or part of the same company).

In some embodiments, the location identification module 406 of the intrusion detection application 208 determines one or more physical locations associated with the particular device in response to the detection of the network intrusion event.

In other embodiments, the location identification module 406 determines that a first device is travelling toward a particular location.

The location tracking module 408 can be software including routines for tracking the location of the network intrusion. In some embodiments, the location tracking module 408 can be a set of instructions executable by the processor 204 to provide the functionality described herein. In some other embodiments, the location tracking module 408 can be stored in the memory 206 of the Intrusion detection application 208 and can be accessible and executable by the processor 204.

In some embodiments, the location tracking module 408 estimates one or more predicted locations of the particular device based on the physical location of the particular device. In such embodiments, the one or more predicted locations correspond to one or more physical pathways by which a device causing the network intrusion may exit a physical environment from the current physical location.

The notification module 410 can be software including routines for notifying the surveillance system 180 of the network intrusion. In some embodiments, the notification module 410 can be a set of instructions executable by the processor 204 to provide the functionality described herein. In some other embodiments, the location tracking module 408 can be stored in the memory 206 of the Intrusion detection application 208 and can be accessible and executable by the processor 204.

The video data processor module 412 can be software including routines for processing video data associated with the network intrusion. In some embodiments, the video data processor module 412 can be a set of instructions executable by the processor 204 to provide the functionality described herein. In some other embodiments, the location tracking module 408 can be stored in the memory 206 of the Intrusion detection application 208 and can be accessible and executable by the processor 204.

The video data processor module 412 processes a video stream comprising images of the estimates one or more predicted locations of the particular device. In some embodiments, processing the video stream includes activating at least one video camera associated with the one or more predicted locations. In some embodiments, processing the video stream includes prioritizing data for the video stream over other data on the network. For example, processing the video stream may mean prioritizing the video corresponding to the network intrusion over other videos. For example, the video corresponding to the network intrusion may have more favorable EDCA parameters than other video, voice, data or background data.

In some embodiments, processing the video stream includes selecting the video stream for presentation to one or more users. For example, processing the video stream may include a multicast distribution of the video to personnel, such as security guards or IT personnel in real time. In some embodiments, for example, if multiple video streams are being recorded or displayed, then the stream related to the network intrusion is selected.

In other embodiments, processing the video stream includes storing a portion of the video stream, that includes images of the one or more predicted locations, separately from other portions of the video stream. For example, processing the video stream includes ensuring that the buffer does not overwrite. In such examples, there may be a separate local server for storing video received.

In yet other embodiments, processing the video stream includes transmitting a portion of the video stream, that includes images of the one or more predicted locations, on a separate network data path than other portions of the video stream. For example, processing the video stream includes ensuring that the buffer does not overwrite. In such examples, there may be a separate local server to where the video data associated with the network intrusion is sent.

### Example Processes

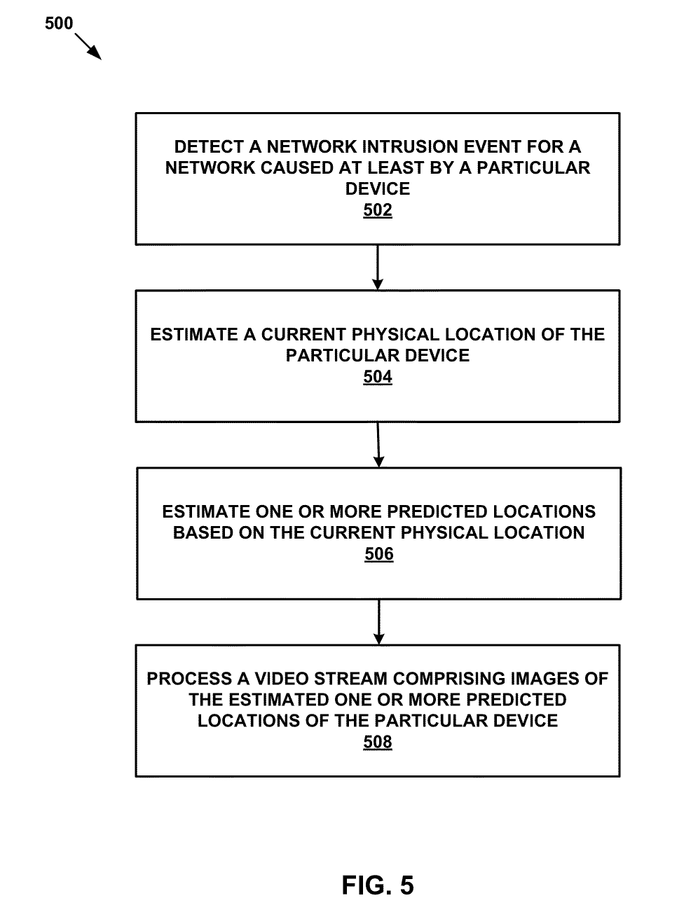

FIG. 5 illustrates an example process 500 for intrusion detection and video surveillance according to embodiments of the present disclosure. The process 500 begins when the intrusion detection module 404 of the intrusion detection application 208 detects 502 a network intrusion event that is being caused by a particular device. In some embodiments, the network intrusion event includes a client device with a particular role connecting to an access point where no client devices with that particular role are expected to connect to that access point. In other embodiments, the network intrusion event may include, but are not limited to the following examples: detection of a rogue access point, DOS attacks, AP spoofing, MAC spoofing, detection of trap set to detect, deflect, or, in some manner, counteract attempts at unauthorized use of the network, a de-authentication broadcast, or any other alert from the network based on network actions.

Next, the location identification module 406 of the intrusion detection application 208 estimates 504 a current physical location of the particular device in response to the detection of the network intrusion event.

Based on the physical location, the location identification module 406 of the intrusion detection application 208 estimates 506 one or more predicted locations of the particular device. In some embodiments, the one or more predicted locations correspond to one or more physical pathways by which a device causing the network intrusion may exit a physical environment from the current physical location. For example, in some embodiments, the one or more predicted locations can be a pathway that leads to an exit of the premises. As another example, in other embodiments, the one or more predicted locations can be all the pathways that lead to an exit from the premises. In some embodiments, the one or more predicted locations are estimated based on the current physical location and a detected direction of travel of the particular device. For example, if a current physical location is detected and the current physical location is located near a stairway, then the one or more predicted locations is the stairway. In such embodiments, the notification module 410 of the intrusion detection application 208 instructs the surveillance system 180 to record the stairway.

In some embodiments, the one or more predicted locations may be a high security zone near the current physical location of the particular device. In other embodiments, the one or more predicted locations may be a high priority zone near the current physical location of the particular device. In yet other embodiments, the one or more predicted locations may be a second current physical location for an individual near the current physical location of the particular device. For example, the one or more predicted locations may be a bank safe. As another example, the one or more predicted locations may be a white room or IT core infrastructure. In such embodiments mention above, where the one or more predicted locations may be a high security zone near the current physical location of the particular device, the proximity may be defined as a distance proximity. However, in some embodiments, the proximity may not necessarily be defined as a distance proximity, but may also be defined as locations that are associated with each other (for example, part of the same department, or part of the same company).

Lastly, the video data processor module 412 processes 508 a video stream comprising images of the estimates one or more predicted locations of the particular device. In some embodiments, processing the video stream includes activating at least one video camera associated with the one or more predicted locations. In some embodiments, processing the video stream includes prioritizing data for the video stream over other data on the network. For example, processing the video stream may mean prioritizing the video corresponding to the network intrusion over other videos. For example, the video corresponding to the network intrusion may have more favorable EDCA parameters than other video, voice, data or background data.

In some embodiments, processing the video stream includes selecting the video stream for presentation to one or more users. For example, processing the video stream may include a multicast distribution of the video to personnel, such as security guards or IT personnel in real time. In some embodiments, for example, if multiple video streams are being recorded or displayed, then the stream related to the network intrusion is selected.

In other embodiments, processing the video stream includes storing a portion of the video stream, that includes images of the one or more predicted locations, separately from other portions of the video stream. For example, processing the video stream includes ensuring that the buffer does not overwrite. In such examples, there may be a separate local server for storing video received.

In yet other embodiments, processing the video stream includes transmitting a portion of the video stream, that includes images of the one or more predicted locations, on a separate network data path than other portions of the video stream. For example, processing the video stream includes ensuring that the buffer does not overwrite. In such examples, there may be a separate local server to where the video data associated with the network intrusion is sent.

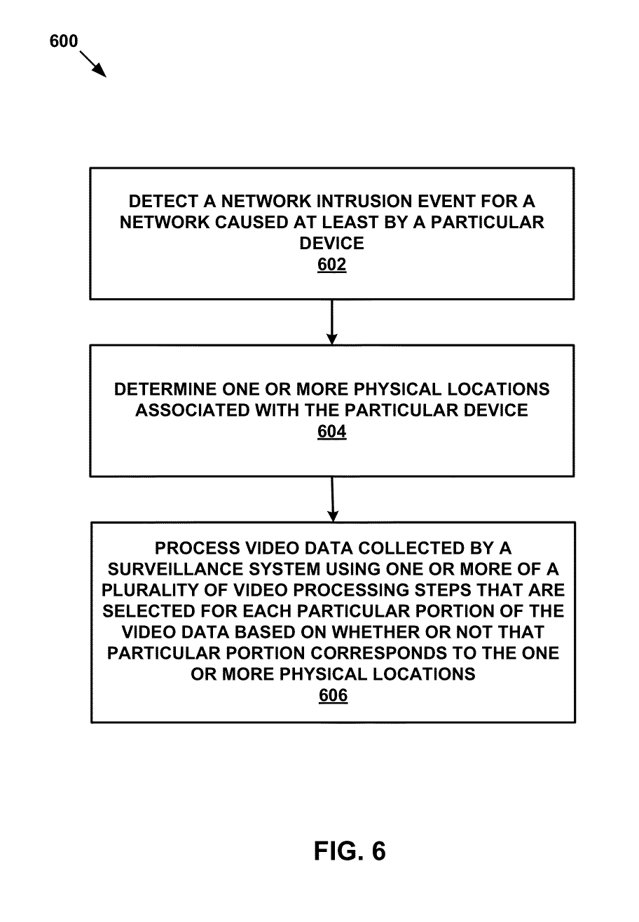

FIG. 6 illustrates another example process 600 for intrusion detection and video surveillance according to embodiments of the present disclosure. The process 600 begins when the intrusion detection module 404 of the intrusion detection application 208 detects 602 a network intrusion event that is being caused by a particular device. In some embodiments, the network intrusion event includes a client device with a particular role connecting to an access point where no client devices with that particular role are expected to connect to that access point. In other embodiments, the network intrusion event may include, but are not limited to the following examples: detection of a rogue access point, DOS attacks, AP spoofing, MAC spoofing, detection of trap set to detect, deflect, or, in some manner, counteract attempts at unauthorized use of the network, a de-authentication broadcast, or any other alert from the network based on network actions.

Next, the location identification module 406 of the intrusion detection application 208 determines 604 one or more physical locations associated with the particular device in response to the detection of the network intrusion event.

Finally, video data processor module 412 processes 606 the video data collected by a surveillance system using one or more of a plurality of video processing steps that are selected for each particular portion of the video data based on whether or not that particular portion corresponds to the one or more physical locations.

For example, in some embodiments, processing the video data includes discarding portions of the video data that do not correspond to the one or more physical locations and storing portions of the video data that correspond to the one or more physical locations.

In some embodiments, processing the video data includes processing portions of the video data that do not correspond to the one or more physical locations with a first priority and processing portions of the video data that correspond to the one or more physical locations with a second priority, wherein the second priority is higher than the first priority. For example, processing the video stream may mean prioritizing the video corresponding to the network intrusion over other videos. For example, the video corresponding to the network intrusion may have more favorable EDCA parameters than other video, voice, data or background data.

In some embodiments, processing the video stream includes selecting the video stream for presentation to one or more users. For example, processing the video stream may include a multicast distribution of the video to personnel, such as security guards or IT personnel in real time. In some embodiments, for example, if multiple video streams are being recorded or displayed, then the stream related to the network intrusion is selected.

In other embodiments, processing the video stream includes storing a portion of the video stream, that includes images of the one or more predicted locations, separately from other portions of the video stream. For example, processing the video stream includes ensuring that the buffer does not overwrite. In such examples, there may be a separate local server for storing video received.

In yet other embodiments, processing the video stream includes transmitting a portion of the video stream, that includes images of the one or more predicted locations, on a separate network data path than other portions of the video stream. For example, processing the video stream includes ensuring that the buffer does not overwrite. In such examples, there may be a separate local server to where the video data associated with the network intrusion is sent.

In some embodiments, the one or more physical locations include a current physical location of the particular device and a predicted physical location of the particular device. In some other embodiments, the one or more physical locations include a current physical location of the particular device or a predicted physical location of the particular device.

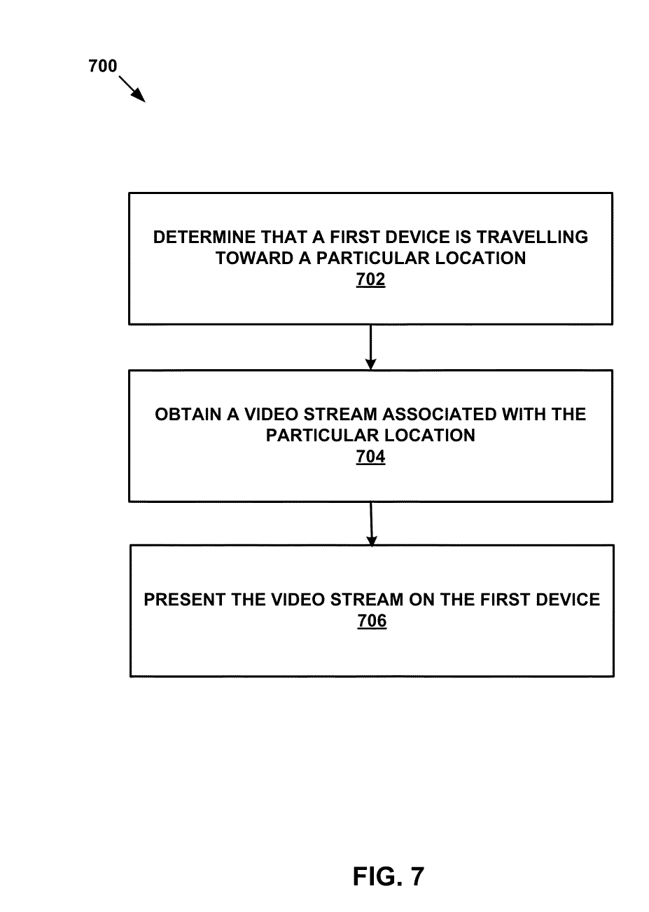

FIG. 7 illustrates an example process 700 for device tracking and video surveillance according to embodiments of the present disclosure. The process 700 begins when the location identification module 406 of the intrusion detection application 208 determines 702 that a first device is travelling toward a particular location. Responsive to determining that the first device is travelling toward the particular location, an instruction is sent to the surveillance system 180 to obtain 704 a video stream associated with the particular location. The video stream is then presented 706 on the first device. In some embodiments, determining that the first device is travelling toward a particular location comprises includes that a signal strength of signals received by a second device, located at the particular location, from the first device is increasing.

The present disclosure may be realized in hardware, software, or a combination of hardware and software. The present disclosure may be realized in a centralized fashion in one computer system or in a distributed fashion where different elements are spread across several interconnected computer systems coupled to a network. A typical combination of hardware and software may be an access point with a computer program that, when being loaded and executed, controls the device such that it carries out the methods described herein.

The present disclosure also may be embedded in non-transitory fashion in a computer-readable storage medium (e.g., a programmable circuit; a semiconductor memory such as a volatile memory such as random access memory “RAM,” or non-volatile memory such as read-only memory, power-backed RAM, flash memory, phase-change memory or the like; a hard disk drive; an optical disc drive; or any connector for receiving a portable memory device such as a Universal Serial Bus “USB” flash drive), which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

As used herein, “digital device” generally includes a device that is adapted to transmit and/or receive signaling and to process information within such signaling such as a station (e.g., any data processing equipment such as a computer, cellular phone, personal digital assistant, tablet devices, etc.), an access point, data transfer devices (such as network switches, routers, controllers, etc.) or the like.

As used herein, “access point” (AP) generally refers to receiving points for any known or convenient wireless access technology which may later become known. Specifically, the term AP is not intended to be limited to IEEE 802.11-based APs. APs generally function as an electronic device that is adapted to allow wireless devices to connect to a wired network via various communications standards.

As used herein, the term “interconnect” or used descriptively as “interconnected” is generally defined as a communication pathway established over an information-carrying medium. The “interconnect” may be a wired interconnect, wherein the medium is a physical medium (e.g., electrical wire, optical fiber, cable, bus traces, etc.), a wireless interconnect (e.g., air in combination with wireless signaling technology) or a combination of these technologies.

As used herein, “information” is generally defined as data, address, control, management (e.g., statistics) or any combination thereof. For transmission, information may be transmitted as a message, namely a collection of bits in a predetermined format. One type of message, namely a wireless message, includes a header and payload data having a predetermined number of bits of information. The wireless message may be placed in a format as one or more packets, frames or cells.

As used herein, “wireless local area network” (WLAN) generally refers to a communications network links two or more devices using some wireless distribution method (for example, spread-spectrum or orthogonal frequency-division multiplexing radio), and usually providing a connection through an access point to the Internet; and thus, providing users with the mobility to move around within a local coverage area and still stay connected to the network.

As used herein, the term “mechanism” generally refers to a component of a system or device to serve one or more functions, including but not limited to, software components, electronic components, electrical components, mechanical components, electro-mechanical components, etc.

As used herein, the term “embodiment” generally refers an embodiment that serves to illustrate by way of example but not limitation.

Some portions of the detailed descriptions are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the foregoing discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Input/output or I/O devices (including but not limited to keyboards, displays, pointing devices, etc.) can be coupled to the system either directly or through intervening I/O controllers.

The particular naming and division of the modules, routines, features, attributes, methodologies and other aspects are not mandatory or significant, and the mechanisms that implement the specification or its features may have different names, divisions and/or formats. Furthermore, as will be apparent to one of ordinary skill in the relevant art, the modules, routines, features, attributes, methodologies and other aspects of the disclosure can be implemented as software, hardware, firmware or any combination of the three. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming.

It will be appreciated to those skilled in the art that the preceding examples and embodiments are example and not limiting to the scope of the present disclosure. It is intended that all permutations, enhancements, equivalents, and improvements thereto that are apparent to those skilled in the art upon a reading of the specification and a study of the drawings are included within the true spirit and scope of the present disclosure. It is therefore intended that the following appended claims include all such modifications, permutations and equivalents as fall within the true spirit and scope of the present disclosure.

While the present disclosure has been described in terms of various embodiments, the present disclosure should not be limited to only those embodiments described, but can be practiced with modification and alteration within the spirit and scope of the appended claims. Likewise, where a reference to a standard is made in the present disclosure, the reference is generally made to the current version of the standard as applicable to the disclosed technology area. However, the described embodiments may be practiced under subsequent development of the standard within the spirit and scope of the description and appended claims. The description is thus to be regarded as illustrative rather than limiting.

What is claimed is:

1. A non-transitory computer readable medium comprising instructions which, when executed by one or more hardware processors, causes performance of operations comprising:
detecting a network intrusion event for a network caused at least by a particular device;
responsive to detecting the network intrusion event:
estimating a current physical location of the particular device;
based on the current physical location, estimating one or more predicted locations of the particular device; and
processing a video stream comprising images of the estimated one or more predicted locations of the particular device.

2. The medium of claim 1, wherein the network intrusion event comprises a client device with a particular role connecting to an access point, wherein no client devices with the particular role are expected to connect to the access point.

3. The medium of claim 1, wherein the one or more predicted locations correspond to one or more physical pathways by which a device, causing the network intrusion, may exit a physical environment from the current physical location.

4. The medium of claim 1, wherein the one or more predicted locations are estimated based on the current physical location and a detected direction of travel of the particular device.

5. The medium of claim 1, wherein the one or more predicted locations comprise one or more of: a high security zone near the current physical location of the particular device, a high priority zone near the current physical location of the particular device, or a second current physical location for an individual near the current physical location of the particular device.

6. The medium of claim 1, wherein processing the video stream comprises activating at least one video camera associated with the one or more predicted locations.

7. The medium of claim 1, wherein processing the video stream comprises prioritizing data for the video stream over other data on the network.

8. The medium of claim 1, wherein processing the video stream comprises selecting the video stream for presentation to one or more users.

9. The medium of claim 1, wherein processing the video stream comprises storing a portion of the video stream, that includes images of the one or more predicted locations, separately from other portions of the video stream.

10. The medium of claim 1, wherein processing the video stream comprises transmitting a portion of the video stream, that includes images of the one or more predicted locations, on a separate network data path than other portions of the video stream.

11. A non-transitory computer readable medium comprising instructions which, when executed by one or more hardware processors, causes performance of operations comprising:
detecting a network intrusion event for a network caused at least by a particular device;
responsive to detecting the network intrusion event:
determining one or more physical locations associated with the particular device;
processing video data collected by a surveillance system using one or more of a plurality of video processing steps that are selected for each particular portion of the video data based on whether or not that particular portion corresponds to the one or more physical locations.

12. The medium of claim 11, wherein processing the video data comprises discarding portions of the video data that do not correspond to the one or more physical locations and storing portions of the video data that correspond to the one or more physical locations.

13. The medium of claim 11, wherein processing the video data comprises processing portions of the video data that do not correspond to the one or more physical locations with a first priority and processing portions of the video data that correspond to the one or more physical locations with a second priority, wherein the second priority is higher than the first priority.

14. The medium of claim 11, wherein processing the video data comprises selecting the portions of the video data that correspond to the one or more physical locations for display to one or more users and refraining from selecting the portions of the video data that do not correspond to the one or more physical locations.

15. The medium of claim 11, wherein processing the video data comprises storing portions of the video data that do not correspond to the one or more physical locations separately from portions of the video data that correspond to the one or more physical locations.

16. The medium of claim 11, wherein processing the video data comprises transmitting portions of the video data that correspond to the one or more physical locations without transmitting portions of the video data that do not correspond to the one or more physical locations.

17. The medium of claim 11, wherein processing the video data comprises transmitting portions of the video data that correspond to the one or more physical locations on a first network data path and transmitting portions of the video data that do not correspond to the one or more physical locations on a second network data path that is different than the first network data path.

18. The medium of claim 11, wherein the one or more physical locations comprise (a) a current physical location of the particular device and/or (b) a predicted physical location of the particular device.

19. A non-transitory computer readable medium comprising instructions which, when executed by one or more hardware processors, causes performance of operations comprising:
determining that a first device is travelling toward a particular location;
responsive to determining that the first device is travelling toward the particular location, obtaining a video stream associated with the particular location; and
presenting the video stream on the first device.

20. The medium of claim 19, wherein determining that the first device is travelling toward a particular location comprises detecting that a signal strength of signals received by a second device, located at the particular location, from the first device is increasing.
